(19) United States
(12) Patent Application Publication
(10) Pub. No.: US 2008/0233204 A1
(43) Pub. Date: Sep. 25, 2008

(54) Anti-Microbial Paint Films

(76) Inventors: Susan M. Horley, Bay Village, OH (US); Colin Pearce, Buckinhamshire (GB); Kenneth Murray, Berkshire (GB)

Correspondence Address: ROETZEL AND ANDRESS, 222 SOUTH MAIN STREET, AKRON, OH, 44308, US

(21) Appl. No.: 11/915,789

(22) PCT Filed: Jun. 9, 2006
(86) PCT No.: PCT/EP2006/005544

§ 371 Date: May 5, 2008

(30) Foreign Application Priority Data
Jun. 9, 2006 (EP) PCTEP06/005544
Jun. 16, 2006 (GB) GB0512194.2

(51) Int. Cl. A01N 59/16; A01P 1/00; A01N 25/00; C09D 5/14

(52) U.S. Cl. 424/618; 514/772.3

(57) ABSTRACT

An anti-microbial, solid architectural paint film produced by applying a liquid paint composition to a work surface, wall, ceiling or floor and allowing it to dry wherein the paint film comprises
i) a film forming polymer and
ii) an anti-microbial substance, comprising a metal or metal compound deposited on a particulate inorganic material, in an effective amount to kill microbes or prevent their growth on the surface of the solid coating and wherein the paint film is free of metallic copper and zinc and their alloys.

### BACKGROUND OF THE INVENTION

This invention relates to anti-microbial architectural paint compositions, solid paint films derived from them and their preparation and use to inhibit and/or prevent microbial growth on said films.

In many everyday situations, ensuring that surfaces are free of microbial contamination is an important factor in maintaining the health of the population. This is particularly so where the people involved are very young, infirm or simply unwell. More recently, the spread of the bacterial infection eMRSA (methicillin resistant staphylococus aureus), especially in hospitals—where it has caused fatalities—has increased the urgency of solving this problem.

Whilst the term ‘paint composition’ may be normally understood to mean coloured or pigmented paint, in the specification herein it should be understood to include unpigmented paints, also known as varnish and clearcoat.

Known methods of maintaining clean surfaces include frequent wiping with antiseptic solutions.

Known paint compositions can contain anti-microbial substances to prevent the growth of bacteria, yeasts and fungi in the liquid paint. These are often organic chemicals such as isothiazalone which are effective at protecting the paint composition in the liquid state. However, they are not very effective at preventing microbial growth on the dried solid paint film derived from the liquid paint. This limited effectiveness deteriorates over time and further still following scrubbing. It is thought that scrubbing the paint surface causes the anti-microbial substance to be lost from the coating through leaching and abrasion. Furthermore, how quickly the bacteria are killed after contacting the paint surface is another important parameter in preventing the spread of disease.

Silver, in the form of metallic silver or silver salts, is known to be toxic to micro-organisms, particularly bacteria, whilst being relatively benign to higher organisms, such as man. It is known that the Romans would drink from silver vessels in order to help prevent the spread of disease.

European Patent (EP) application 0 333 118 discloses the use of anti-microbial powders in coatings, the powder consisting of metallic copper, zinc or alloys thereof, deposited on titanium oxide. EP 0 427 858 discloses anti-bacterial fibres made by incorporating an anti-microbial powder, based on silver chloride deposited on titanium dioxide, in the polymer spinning solution. More recently WO 03/039766 discloses packaging material coated with a composition containing a zeolite based anti-microbial powder. In U.S. Pat. No. 6,444,726, a synergistic combination of the anti-microbial substance and sodium dioctyl sulphosuccinate surfactant is described, allowing, what are described as reduced levels of the anti-microbial material to be used in compositions including coatings. European Patent 0 190 504 describes the deposition of metallic silver on particles of metal oxides and hydroxides and their use in medical appliances, such as catheters to prevent microbial infection at the point of use. However, none of the prior art discloses architectural paint compositions containing such anti-microbial substances nor their use to prevent microbial growth in the solid state when the liquid paint is applied to a substrate such as a work surface, wall, ceiling or floor and allowed or caused to dry.

In critical environments, such as hospitals and kitchens, inadvertent microbial contamination of surfaces can lead to the rapid spread of disease, initially from surface to person and then from person to person. This can lead to serious and sometimes fatal consequences. The appearance of antibiotic resistant bacteria, such as eMRSA has served to exacerbate the situation. Traditionally, the spread of disease has been prevented by frequent, rigorous and thorough cleaning of work surfaces using antiseptic solutions. This is very time consuming and expensive and inevitably leads to some areas being missed thereby remaining contaminated. In particular, large areas such as walls and floors are less likely to be thoroughly washed and thus protected from supporting microbial growth. Thus, there is a need for architectural coating compositions which dry to form solid paint films which are capable of killing or at least preventing the growth of any microbes which come into contact with the surface of the solid paint film.

### SUMMARY OF THE INVENTION

An anti-microbial, solid architectural paint film produced by applying a liquid paint composition to a work surface, wall, ceiling or floor and allowing it to dry where the paint film is a film forming polymer and an anti-microbial substance, which is a metal or metal compound deposited on a particulate inorganic material, in an effective amount to kill microbes or prevent their growth on the surface of the solid coating and wherein the paint film is free of metallic copper and zinc and their alloys.

### DETAILED DESCRIPTION OF THE INVENTION

Accordingly, in a first aspect the invention provides an anti-microbial, solid architectural paint film produced by applying a liquid paint composition to a work surface, wall, ceiling or floor and allowing it to dry wherein the paint film comprises

i) a film forming polymer and

ii) an anti-microbial substance, comprising a metal or metal compound deposited on a particulate inorganic material, in an effective amount to kill microbes or prevent their growth on the surface of the solid coating and wherein the paint film is free of metallic copper and zinc and their alloys.

In a second aspect the invention provides a method of killing microbes or preventing their growth on solid coatings.

The solid paint film is derived from the liquid paint composition by applying it to a substrate and allowing or causing it to dry. Suitable methods of application include brush, roller, spray and blade.

The coating composition is preferably aqueous, by which is meant that at least 50% by weight of the continuous phase is water, the remainder being organic solvent, more preferably water compatible organic solvent. Waterborne coating compositions are preferred, particularly when applied in enclosed spaces, as the amount of noxious fumes is reduced or indeed eliminated. This is especially important in hospitals. Most preferably the composition is free of organic solvent.

The microbes against which the solid coating is effective includes bacteria, yeasts and fungi. It is especially effective against methicillin resistant Staphylococcus aureus, Escherichia coli and Pseudomonas acurginosa.

The film forming polymer should be capable of forming a continuous film at or about room temperature. A wide variety of such polymers is available, but those most commonly used in coating compositions are of three broad types obtained from mono-ethylenically unsaturated monomers and known colloquially as the “acrylics”, the “vinyls” and the “styrenics”. The “acrylics” are usually copolymers of at least two alkyl esters of one or more mono-ethylenically unsaturated carboxylic acids (e.g. methyl methacrylate-butyl aerylate copolymer) whilst the “vinyls” usually comprise copolymers of a mono-vinyl ester of a saturated carboxylic acid and at least one of either an acrylic monomer or a different mono-vinyl ester. Copolymers of ethylene and vinyl acetate are also useful. The “styrenics” are copolymers containing styrene (or a similar mono-vinyl aromatic monomer) together with a copolymerisable monomer which is usually an acrylic. Polyurethane and polyurethane-acrylic polymers are also useful film forming polymers. The polyurethane portion of such polymers is generally formed by reacting polyisocyanates with diols and chain extending to increase the molecular weight.

Such film-forming binder polymers may be produced as solution copolymers or dispersion copolymers in a carrier liquid. Solution copolymers are substantially dissolved in the carrier liquid whereas dispersion copolymers are produced as discrete polymer particles in the carrier liquid. The solventborne or aqueous dispersions of particles require stabilisers, sometime referred to as emulsifiers or surfactants, to prevent the particles from flocculating and forming a sediment, thereby improving the storage and shear stability of the dispersion. Dispersing moieties can be copolymerised into the polymer to help dispersion. For example, in aqueous polymer dispersions the copolymer may contain acid moieties, such as methacrylic acid. Neutralising such moieties with a suitable base, facilitates dispersion. The carrier liquid may be organic solvent or preferably an aqueous medium. Typically the carrier liquid used to make a solution copolymer is a liquid which is a good solvent for the copolymer concerned such that the copolymer is substantially dissolved in it. Where the carrier liquid is aqueous, at least 50% by weight of the liquid is water with the remainder being water compatible organic solvent or solvent mixture. The polymer particles must coalesce to form a continuous film at the temperature of use. Of course, external plasticizers may be used to achieve this. Suitable such plastici/ers include Texanol.

It is thought that the effectiveness of the solid paint film to inhibit the growth of bacteria on its surface, requires that the silver is accessible, in some form, at the surface.

The effective amount of the anti-microbial substance in the coating composition and thus the solid coating will depend on how much metal or metal compound, bound to the particulate inorganic material, is introduced to the coating composition, and of course, its anti-microbial activity. We have found that surprisingly low amounts are required of the metal. Preferably from 5 to 250 ppm calculated on a weight basis of the solid coating composition is sufficient to prevent the growth and indeed kill most of the bacteria on the solid coating surface. More preferably from 10 to 250 even more preferably from 5 to 150 ppm, yet more preferably from 10 to 120 ppm and most preferably from 30 to 90 ppm. These amounts are preferred as at such levels little or no discoloration is evident in the solid coating. Below 90 ppm, no discoloration is observed, between 90 and 250 some discoloration is observed albeit acceptable in the pastel colours. Above about 250 ppm the discoloration is acceptable only in the darker colours This is especially important as consumers prefer white or lightly coloured pastel shades, which are more likely to be affected by any darkening due to the metal or metal compound. In fact, it is thought that the discoloration is caused by the metal itself. Hence, metal compounds are preferred, although, these too can contain some reduced metal, for example metallic silver where the metal compound is a silver compound.

The metal compound is preferably a metal salt having low solubility in the continuous phase of the coating composition as this encourages it to deposit on or in the particulate inorganic material. More preferably it is a silver salt. Suitable such salts include the silver halides such as silver chloride.

The particles of the particulate inorganic material are preferably of mean particle diameter less than 5 microns, more preferably less than 4 microns, even more preferably less than 3 microns, still more preferably less than 2 microns and most preferably less than 1 micron. The advantage of small particle size is that the antimicrobial substance is evenly distributed throughout the solid coating thereby providing effective protection across the whole area of substrate painted. In addition, the small particle size provides a large surface area for the metal or metal compound to be deposited and/or adsorbed and be carried. Preferably, the inorganic material may be porous, thereby providing a yet larger surface area for the metal or metal compound to be carried.

Preferably, the inorganic material is a metal oxide. Suitable metal oxides include the oxides of titanium, magnesium, aluminium, silicon, cerium, zirconium, and tantalum. However, the zeolite group of alumino silicate inorganic materials are preferably avoided because they impart a grey colour to the finished paint even at low levels, preferably, titanium dioxide is used as most paints already contain at least some of this white pigment. Additionally, the use of silver or silver halides, and silver chloride in particular as the anti-microbial compound, brings a risk of some darkening in the resultant dried coating. Titanium dioxide has a high refractive index and thus scatters light thereby at least partially offsetting any tendency of the coating to darken.

The metal compound should be deposited on the inorganic material to form the anti-microbial substance. Whilst not wishing to be bound by this, it is thought that the metal compound is bound to the inorganic material in the sense that the two prefer to be together, rather than that a covalent bond is formed, although such a bond may be formed. It seems likely that the low solubility of the metal compound in the continuous phase of the paint is such that it preferentially exists on the surface or within any pores of the inorganic material. Suitable examples of anti-microbial substance include silver chloride deposited on titanium dioxide. This is conveniently available in powder form as Biosilver PG or as an aqueous dispersion as Biosilver LP 10, comprising 10 wt % nv. The powder form is free of sodium dioetyl sulphosuccinate whereas the aqueous dispersion contains about 15% by weight of this surfactant. Where the presence of the sodium dioctyl sulphosuccinate causes adverse effects, it is preferred to use the powder form or, indeed any other anti-microbial substance free of this surfactant.

In a third aspect the invention provides a tinting system comprising an anti-microbial substance bound to a particulate inorganic material.

The anti-microbial substance may be added to the paint at the factory at any stage of the paint making process and supplied ready for use to the consumer. It is preferable to add the substance after any high shear stirring is complete to avoid damaging the structure of the particles. Alternatively the anti-microbial substance can be added to die paint as part of an in-store or in-depot tinting system, thereby minimising the amount of valuable anti-microbial substance tied up in large stocks of variously coloured paints. In-store or in-depot tinting allows many colours to be made from a small number of unfinished base paints and coloured tinters according to recipes stored on microfiche or computer memory. The recipes direct the operator first to select the appropriate coloured base paint, typically selected from a light, medium or deep coloured paint and second to add appropriate amounts of the chosen tinters themselves. Incorporation of the anti-microbial can be effected by vigorous shaking, for example as provided by a Red Devil™ shaker.

The coloured tinters usually, but not always, comprise single pigment dispersed in a fluid medium optionally in the presence of dispersant. The dispersant helps to produce a pigment dispersion which is stable over long time periods and which is also easy to mix with the base paint without causing flocculation of the pigment or indeed any other ingredient of the paint. Similarly, the anti-microbial substance may be formulated into a tinter using similar principles so that it too may be added to a base paint without the anti-microbial substance flocculating. In such a system of course, the anti-microbial substance is not a true tinter in that it is not being added for its colour properties, but rather it has the properties of a tinter in that it can be easily added and incorporated into the base paint by simple mixing or shaking.

Formulating the anti-microbial substance in the form of a tinter and adding it as part of a tinting system allows the paint manufacturer to supply colours with or without the anti-microbial tinter component. In this way, where the paint is required for a hygiene critical use, such as hospital walls or kitchens, the user can specify the colour with the anti-microbial substance, and where the paint is to be used elsewhere the paint need not have anti-microbial substance thereby reducing the cost.

A method is also provided of killing microbes or preventing their growth on a solid paint film, comprising contacting the microbes with a solid paint film derived from a coating composition according to the invention. Preferably the microbes are selected from the group consisting of methieillin resistant Staphylococcus Aureus, Escherichia Coli and Pseudomonas A aeurginosa.

A method is also provided of producing an anti-microbial solid coating by providing a coating composition comprising an anti-microbial substance of the invention and allowing or causing the coating to dry.

There is also provided a use of a solid paint film coating derived from an anti-microbial coating composition to prevent the growth of microbes, especially bacteria.

A substrate coated with an anti-microbial paint film of the invention is also provided. Suitable substrates are usually found in buildings such as dwellings, hospitals, commercial premises including offices and restaurants. They include walls, ceilings, doors, floors and work surfaces.

### EXAMPLES

The invention will now be illustrated by the following examples.

The ingredients listed below were used in the preparation of the examples.

Dulux™ Trade Flat matt emulsion (white)-available from ICI Paints, Slough, Great Britain, SL2 5DS.

Dulux™ Trade Quick Drying Fggshell (yellow and black)—available from ICI Paints, Slough, Great Britain, SL2 5DS.

Biosilver™ LP10-10% solids of anti-microbial substance and contains 1.4% by weight of silver. Available from Addmaster of Stafford UK.

Leneta panels—available from Cornelius Chemical Co, Bishops Stortford, Herts, CM23 5RG

Sheen Wet Abrasion Scrub tester machine, model number 903, available from Sheen Instruments Ltd, Kingston-upon-Thames, Surrey, KT2 5BQ.

To 1 kg of each of the paints was added 2 g of Biosilver LP10 and mixed using a red devil mixer.

The paints were labelled as indicated below.

1A Dulux™ Trade Flat matt emulsion (white)

1B Dulux™ Trade Flat matt emulsion (white) with 0.2% by weight of Biosilver LP10 added

2A Dulux™ Trade Quick Drying Lggshell (yellow)

2B Dulux™ Trade Quick Drying Lggshell (yellow) with 0.2% by weight of Biosilver LP10 added

3A Dulux™ Trade Quick Drying Lggshell (black)

3B Dulux™ Trade Quick Drying Lggshell (black) with 0.2% by weight of Biosilver LP10 added

Dulux™ Trade Flat matt emulsion is an aqueous paint of solids content of 57 wt % based on a waterborne acrylic latex.

Dulux™ Trade Quick Drying Eggshell is an aqueous paint of solids content approximately 50 wt % based on a waterborne latex.

Each paint was spread on Leneta panels using a block spreader producing 200 micron wet film thickness. These were allowed to dry at room temperature of about 22° C. whereby a solid paint film of approximately 70 microns was produced. Half of each panel was scrubbed 500 times using a Sheen Wet Abrasion Scrub tester machine according to British Standard test BS 7719:1994. The coated Leneta panels were cut into sections of 30 mm×30 mm and a suspension, in sterile distilled water, of eMRSA (methicillin resistant Staphylococcus aureus (NCTC 11939), Escherichia coli (ATCC 8739) or Pseudomonas aeurginosa (ATCC 15442) was placed on the surface of the dried solid paint (the alpha-numerics in brackets refer to the culture collection number, identifying the strain of bacterium used). These sections were incubated for up to 12 hours at 20° C. and 65% relative humidity and an estimate made of the surviving bacteria, expressed as CFU cm² (colony forming units), over time. The data is summarised below in which Table 1 refers to eMRSA, Table 2 refers to E coli and Table 3 to Ps aeurginosa.

TABLE 1

| eMRSA | | | | | |
|---|---|---|---|---|---|
| Solid coating | Exposure Time | | | % Reduction | |
| derived from | 0 | 6 hrs | 12 hrs | 6 hrs | 12 hrs |
| 1A | 1.0E+06 | 4.4E+05 | 9.1E+05 | | |
| 1B | 1.0E+06 | 4.0E+05 | 1.8E+05 | 9.1 | 80.2 |
| 1A (scrubbed) | 1.0E+06 | 2.1E+05 | 8.5E+05 | | |
| 1B (scrubbed) | 1.0E+06 | 2.7E+03 | 2.5E+01 | 98.7 | 100.0 |

TABLE 2

| Ps aeurginosa | Exposure | | | | |
|---|---|---|---|---|---|
| Solid coating | Time | | | % Reduction | |
| derived from | 0 | 6 hrs | 12 hrs | 6 hrs | 12 hrs |
| 1A | 8.1E+05 | 4.2E+05 | 8.8E+03 | | |
| 1B | 8.1E+05 | 3.3E+04 | 2.5E+01 | 92.2 | 99.7 |
| 1A (scrubbed) | 8.1E+05 | 4.2E+05 | 4.2E+04 | | |
| 1B (scrubbed) | 8.1E+05 | 3.3E+04 | 2.5E+01 | 92.2 | 99.9 |

The data is expressed in CFUs cm² and also as a percentage reduction. The percentage reduction refers to the proportion of bacteria killed by the anti-microbial coating relative to the amount killed by the standard paint over the same incubation period.

TABLE 3

| E coli | | | | | |
|---|---|---|---|---|---|
| Solid coating | Exposure Time | | | % Reduction | |
| derived from | 0 | 6 hrs | 12 hrs | 6 hrs | 12 hrs |
| 1A | 6.6E+05 | 1.1E+06 | 8.5E+05 | | |
| 1B | 6.6E+05 | 7.4E+04 | 2.5E+01 | 93.2 | 100.0 |
| 1A (scrubbed) | 6.6E+05 | 3.9E+05 | 1.0E+04 | | |
| 1B (scrubbed) | 6.6E+05 | 9.4E+02 | 2.5E+01 | 99.8 | 99.8 |

The effect of adding the anti-microbial substance to the liquid coating composition is a significant reduction in the number of bacteria surviving on the surface of the derived solid coating. This happens unexpectedly quickly, and in most cases almost all of the bacteria are killed within 6 to 12 hours. The bacterium eMRSA, appears to survive longer but even with this the population is reduced by at least 80% after 12 hours.

It is also significant that scrubbing the coating does not adversely affect its effectiveness at preventing the growth of the bacteria. In fact, the data suggests that scrubbing improves the performance, especially at 6 hours. Repeated washing and wiping of the paint with a cloth soaked in water or household cleaners containing anionic surfactants does not affect the anti-bacterial performance of the paint. This is especially important to maintain the anti-microbial performance of the dry coating before and after cleaning in hygiene sensitive areas such as hospitals and kitchens.

The effect of different pigments on the antimicrobial activity of the paint was evaluated by adding 0.2% Biosilver LP10 to Dulux™ Trade Quick Drying Eggshell (QDE) in yellow and black. The black pigment in particular comprises small particle size with a porous surface that could affect anti-microbial activity in the dry, solid coating. The yellow pigment used was Yellow 74 and is frequently found in creamy coloured pastel coloured paints. Yellow dried paints were prepared according to the procedure described above and tested for their effect against eMRSA, E coli and Pseudomonas acurginosa. The black was tested against eMRSA only. The data is shown in Tables 4 to 7 respectively.

TABLE 4

| QDE (Yellow) | | | | | |
|---|---|---|---|---|---|
| eMRSA | Exposure | | | % | |
| Solid coating | Time | | | reduction | |
| derived from | 0 | 6 | 12 | 6 hrs | 12 hrs |
| 2A | 1.00E+06 | 5.70E+05 | 2.90E+04 | | |
| 2B | 1.00E+06 | 4.40E+05 | 1.70E+03 | 22.8% | 94.1% |
| 2A (scrubbed) | 1.00E+06 | 3.50E+05 | 5.00E+05 | | |
| 2B (scrubbed) | 1.00E+06 | 1.40E+03 | 2.50E+01 | 99.6% | 100.0% |

TABLE 5

| QDE (Yellow) | | | | | |
|---|---|---|---|---|---|
| E coli | Exposure | | | % | |
| Solid coating | Time | | | reduction | |
| derived from | 0 | 6 | 12 | 6 hrs | 12 hrs |
| 2A | 6.60E+06 | 4.60E+05 | 8.60E+05 | | |
| 2B | 6.60E+06 | 1.70E+05 | 2.50E+01 | 63.0% | 100.0% |
| 2A (scrubbed) | 6.60E+06 | 3.50E+05 | 5.00E+05 | | |
| 2B (scrubbed) | 6.60E+06 | 1.60E+03 | 2.50E+01 | 99.5% | 100.0% |

TABLE 6

| QDE (Yellow) | | | | | |
|---|---|---|---|---|---|
| Ps aeurginosa | Exposure | | | % | |
| Solid coating | Time | | | reduction | |
| derived from | 0 | 6 | 12 | 6 hrs | 12 hrs |
| 2A | 8.10E+05 | 2.00E+05 | 1.60E+03 | | |
| 2B | 8.10E+05 | 1.30E+05 | 2.50E+01 | 35.0% | 98.4% |
| 2A (scrubbed) | 8.10E+05 | 1.80E+05 | 6.10E+05 | | |
| 2B (scrubbed) | 8.10E+05 | 2.40E+04 | 2.50E+01 | 86.7% | 100.0% |

TABLE 7

| QDE (Black) | | | | | |
|---|---|---|---|---|---|
| eMRSA | Exposure | | | % | |
| Solid coating | Time | | | reduction | |
| derived from | 0 | 6 | 12 | 6 hrs | 12 hrs |
| 3A | 1.00E+06 | 8.60E+05 | 1.10E+06 | | |
| 3B | 1.00E+06 | 1.50E+05 | 1.80E+03 | 82.6% | 99.8% |
| 3A (scrubbed) | 1.00E+06 | 8.50E+05 | 5.10E+05 | | |
| 3B (scrubbed) | 1.00E+06 | 2.10E+02 | 7.90E+01 | 100.0% | 100.0% |

The results were substantially the same as for the paints 1A and 1B described above, showing that microbial growth is prevented in paints containing a variety of pigment types.

1. An anti-microbial, solid architectural paint film produced by applying a liquid paint composition to a work surface, wall, ceiling or floor and allowing it to dry wherein the paint film comprises
i) a film forming polymer and
ii) an anti-microbial substance, comprising a metal or metal compound deposited on a particulate inorganic material, in an effective amount to kill microbes or prevent their growth on the surface of the solid coating and wherein the paint film is free of metallic copper and zinc and their alloys.

2. A paint film according to claim 1 wherein the metal is silver or the metal compound is a silver compound.

3. A paint film according to claim 2 wherein the silver compound is a silver halide.

4. A paint film according to claim 3 wherein the silver compound is silver chloride.

5. A paint film according to claim 1 wherein the amount of metal from the anti-microbial substance present in the solid paint, is from 10 to 250 ppm by weight.

6. A paint film according to claim 1 wherein the amount of the metal from the anti-microbial substance present in the solid paint, is from 5 to 150 ppm by weight.

7. A paint film according to claim 1 wherein the anti-microbial substance is zeolite-free.

8. A paint film according to claim 1 wherein the particulate inorganic material is titanium dioxide.

9. A paint film according to claim 1 and which additionally is free of sodium dioctyl sulphosuecinate surfactant.

10. A paint film according to claim 1 wherein the liquid paint composition from which it is derived is aqueous.

11. A method of killing microbes or preventing their growth on a solid paint film, comprising contacting the microbes with the solid paint film of any one of the preceding claims.

12. A work surface, wall, ceiling or floor when coated with an anti-microbial pamt film according to claim 1.
